(19) United States
(12) Patent Application Publication
(10) Pub. No.: US 2018/0007877 A1
(43) Pub. Date: Jan. 11, 2018

(54) Superhydrophobic Fishing Rod Guide

(71) Applicant: Joel David DeJong, Fort Collins, CO (US)

(72) Inventor: Joel David DeJong, Fort Collins, CO (US)

(21) Appl. No.: 15/402,454

(22) Filed: Jan. 10, 2017

Related U.S. Application Data
(60) Provisional application No. 62/358,650, filed on Jul. 6, 2016.

(51) Int. Cl. A01K 87/04; A01K 97/16; B23K 26/352; A01K 91/06; B23K 26/00; B08B 17/06

(52) U.S. Cl. CPC A01K 87/04; B23K 26/0084; B08B 17/065; B23K 26/352; A01K 91/06; A01K 97/16

(57) ABSTRACT

The present invention is directed to an improved fishing rod guide. In one embodiment the improved fishing rod includes superhydrophobic metal guides. The superhydrophobic metal guides make it possible for fishing line, including, for example, fly fishing line and conventional fishing line, to move through the guides with less weight and drag due to water and ice accumulation, allowing for significantly greater distance and ease in casting. Additionally, the decrease in friction between the fishing line and line guides help extend the life of the fishing line.

### FIELD OF INVENTION

The present invention relates generally to an improved fishing rod line guide with an improved guide surface, and, more particularly, to a fishing rod line guide surface with superhydrophobic properties to reduce line friction due to water accumulation and that resists freezing in cold environments.

### BACKGROUND OF THE INVENTION

For centuries, anglers have looked to gain advantages over their quarry, be it trout, bass, tarpon, or any other variety of game fish. One of the many sought-after advantages that has eluded the fishing industry is to overcome losses in fishing line momentum due to the friction caused by accumulation of water or ice on the line at the guides in a way that is robust, consistent, efficient for the caster, and effective. The ability to cast a fly, bait, lure, or other similar item over longer distances is one of angling's primary preoccupations. Casting further and with greater ease grants the angler a number of benefits, including the ability to reach fish hitherto out of casting distance. Extended distance in casting also allows an angler to present the fly, bait, lure, or similar item to a greater number of fish on each cast, as the casting range is increased. Additionally, a longer casting range means anglers have an increased ability to target fish without “spooking” them—that is to say, without alerting the fish to the anglers' presence. Whether wading in a body of water, standing on a bank or pier, or when fishing from a boat, a significant distance between an angler and the targeted fish is generally desired so that the fish remains unaware of the angler's presence.

While fishing rod line guide and fishing line technologies have made significant advances over the years, there remains one major impediment. Water, be it from the body of water being fished, precipitation, or humidity, invariably collects on the fishing line which then accumulates on the guides (see FIGS. 1, 2, 3, and 4) during both the retrieve and cast. The drag on the fishing line created by the surface tension of the water between the fishing line and the line guide has an adverse effect on the speed of line travel and, subsequently, the distance of the cast. Furthermore, in cold temperatures, water that collects on the guides forms ice in, on, and around the guide eyelet, shoulder, and heel (see FIG. 4). Ice in, on and around the guides makes both the casting and the retrieval of line much more difficult for the following reasons: the inside diameter of the guide is reduced from the accumulation of ice, making it harder for the line to pass through it; ice crystals cause more friction on the line; and pieces of the ice break loose from the iced-over guides and affix themselves to the line, making the line far less drag-resistant.

A number of methods and products currently exist to help prevent ice buildup on the rod guides. Perhaps the oldest and simplest method is to place the rod guides under water for a period of time. The coldest a body of water can get before icing over is generally about 33° F.; therefore, placing the line guides under water will eventually cause the ice to melt. While this method is advantageous in that it is free of cost, it is far from ideal. First, holding the rod under water long enough for the ice to melt takes precious time away from fishing. Second, once the rod is removed from the water, the water remaining on the guide often quickly refreezes, forcing the angler to again stop fishing in order to submerge the rod guides and melt the ice. Finally, this method does not remove the water from the guide, and so casting distance remains impeded.

Another common method for ice removal is to chip the ice off the guides with one's hand or fingertips. While this method is faster than submerging the rod, it too has distinct disadvantages. Most critically, it increases the risk of damaging the rod guide. Furthermore, many fishing rods are 9′ or more in length, which makes reaching both ends of the rod with one hand (especially when the angler is wading in a body of water away from shore) very difficult for many anglers. Some anglers choose to whip the rod against the water or the ground with the intent of breaking the ice off the guides. Again, this method is faster than soaking, but the aggressive whipping action needed to snap the ice off can cause expensive or irreparable damage to both rod and guides. Furthermore, in many fishing scenarios, whipping the rod against the water creates a startling noise that can scare fish away from the area, thus greatly diminishing the angler's chances at catching fish.

A number of fishing-specific application products are on the market that claim to reduce or eliminate guide ice. For example, Loon Outdoors offers a product called Stanley's Ice Off Paste. It is an anti-freeze paste that the angler applies by hand to each individual guide. While the product helps retard ice buildup, it does so with a number of distinct disadvantages. First, it places an unnecessary and time-consuming burden on the angler who must manually apply the product to each guide before fishing. This process must be repeated each time the angler desires to fish. Second, the paste does not stand up well to abrasion; often times, the angler must recoat each guide multiple times throughout the fishing expedition. This means that the angler must spend more time treating the rod guides, resulting in less time fishing. Third, because the product must be applied frequently, it places a financial burden on the angler as the product needs to be replenished. Furthermore, the paste creates more drag on the fishing line than water alone, making it more difficult to cast while also shortening the distance of the cast. Finally, the paste also weighs down the line by adding mass to the line, which makes it more difficult to cast over long distances.

Many non-commercial methods of de-icing are also practiced by anglers. One popular “home remedy” involves carrying a spray bottle filled with automotive antifreeze. The angler sprays each guide before fishing, and then again as needed throughout the fishing time. While this method is easier than applying an antifreeze paste, it comes with its own set of problems, not the least of which is the environmental damage inherent in using a toxic chemical on a given body of water. Furthermore, this approach can result in a residual buildup of antifreeze on the line. This residue can not only adversely affect reel mechanisms, but it also gradually degrades the integrity of the fishing line itself (be it conventional line or fly fishing line, as these materials are designed to be coated in these products), ultimately placing an additional financial burden on the angler as it becomes necessary to replace fishing line with greater frequency.

Other commercial products unintended for fishing frequently used to keep guides free from ice include PAM Cooking Spray and WD-40. Both products are relatively inexpensive, but neither lasts long before a reapplication is necessary. WD-40 has the additional disadvantage of being made of chemicals that are not environmentally friendly (much like the aforementioned antifreeze), as well as producing a scent that repels fish. PAM cooking spray does not produce a fish-repelling scent, but does tend to coat line and reel components over time with an oily substance, and this substance also weighs down the line by adding mass to the line, ultimately making it more difficult to cast the line and so shortens the distance of the cast.

Another common “home remedy” is to use a petroleum-based chapstick or lip balm to coat each guide prior to fishing. While this method does help in slowing the buildup of ice on the guides, the petroleum in the chapstick or lip balm will degrade the integrity of the line over time, and likewise places an unnecessary financial burden on the angler who will need to replace the fishing line with greater frequency. Beyond the issue of line degradation, this method is temporary because the chapstick or lip balm does not stand up well to abrasion; frequent reapplications are necessary. Finally, the lip balm or chapstick puts even more drag on the fishing line than water, and adds even more weight to the line than does accumulated water, making the line more difficult to cast and shortening the casting distance.

U.S. Pat. No. 5,175,953 to Richard J. Lesnock, dated Jan. 5, 1993, discloses a conventional fishing rod with electronic eyelet de-icing. Lesnock discloses a fishing rod that contains a battery-powered heating element embedded in the handle of the fishing rod. The adjustable heating element is electrically connected to the line guides via wires contained within the hollow body of the rod. When fishing in an environment that can produce ice build-up on the guides, the angler inserts batteries into the heating device. When the heating device is in operation, the heat generated from the electrical charge running to one or more line guides would melt any ice that had accumulated on the guide. While it is granted that this device would work to melt guide ice, this approach has a number of problems. First, the device requires batteries to operate, and therefore presents an additional financial burden for the angler. Second, said batteries will inevitably lose power, at which point the angler must stop fishing in order to replace spent batteries with new ones, a process which causes the angler to lose valuable fishing time. Third, the heating device significantly increases the overall weight of the rod, however, anglers of both the conventional and fly fishing variety generally prefer lightweight rods as they provide greater sensitivity and cause less fatigue when casting or otherwise handling the fishing rod. While an increase in rod weight may not be as big an issue for the conventional angler, for the fly fishing angler this increase in weight, especially when concentrated in the handle, interferes dramatically with the balance of the rod, which results in a substantial increase in casting fatigue. Finally, this approach does not remove water from the guide, which means resistance and drag on the line will is not reduced.

R. L. Winston Rod Company has recently attempted to improve casting distance by designing a line guide for fly fishing rods that reduces friction between the line and the guide. These guides are generally more circular, but do not eliminate the effect of water or ice build-up on the guide, which creates drag during the cast, thus inhibiting greater casting distance and increases casting effort.

The above mentioned remedies fail to address the hydrophobic/hydrophilic properties of the guide itself without the benefits of the remedies dissipating quickly during a fishing expedition, threatening long-term damage to the fishing rod, line, or guides, and/or causing undue additional weight and frictional losses during casting.

### SPECIFICATION

### Brief Summary of the Invention

The present invention is directed to an improved fishing rod guide. In one embodiment the improved fishing rod includes superhydrophobic metal guides. The superhydrophobic metal guides make it possible for fishing line, including, for example, fly fishing line and conventional fishing line, to move through the guides with less weight and drag due to water and ice accumulation, allowing for significantly greater distance and ease in casting.

### BRIEF DESCRIPTION OF THE DRAWINGS

FIG. 1 illustrates a standard fishing rod used for fly fishing.

FIG. 2 illustrates an embodiment of a tip top guide.

FIG. 3 illustrates an embodiment of a snake guide.

FIG. 4 illustrates a stripping guide.

### BRIEF DESCRIPTION OF THE DRAWINGS

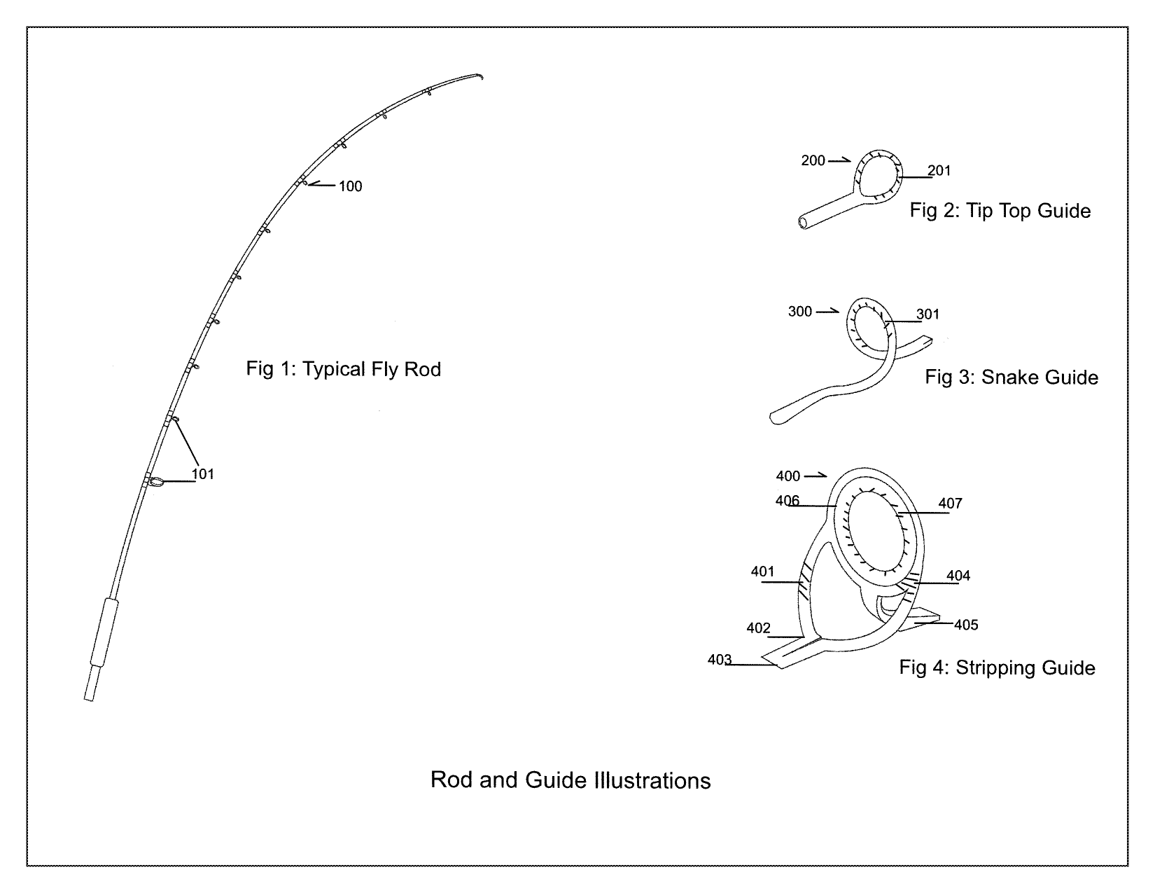

As shown in FIG. 1, a standard fishing rod 100 includes one or more guides 101 of various shapes. A preferred embodiment of the present invention includes a tip top guide 200 as shown in FIG. 2, a snake guide 300 as shown in FIG. 3, and a stripping guide 400 as shown in FIG. 4. In a preferred embodiment, the tip top guide, snake guide, and stripping guide are comprised of a metal, ceramic, or plastic material commonly used in fishing rods. One of ordinary skill in the art, however, will understand that the guides can be made of any material sufficiently rigid enough to allow a fishing line to pass through and hold it in place. The stripping guide includes a leg 401, heel 402, toe 403, shoulder 404, foot 405, and eye 406.

In a preferred embodiment, the tip top guide 200 is designed to encompass a fishing line that passes through an opening in the center. The tip top preferably includes a superhydrophobic section 201 disposed on the portion of the tip top guide that faces inward. In another preferred embodiment, the snake guide 300 is designed to encompass a fishing line that passes through an opening in the center. In another preferred embodiment, the stripping guide 400 is designed to encompass a fishing line that passes through an opening in the center. A person of ordinary skill in the art will understand that FIGS. 2 through 4 are representative samples of shapes of guides used on fishing rods and that various other shapes could be used so long as they allow for a fishing line to pass through and serve to position the line next to the rod.

A hydrophobic material or section is one that resists or repels water. A Superhydrophobic material or section of material is one that resists or repels water better or more efficiently (e.g., has a higher hydrophobicity) than materials commonly used in a given application and thus includes highly hydrophobic, ultrahydrophobic, and other like materials. Superhydrophobic materials include those that have been treated to create micro-scale and/or nanoscale patterns on the face of the material, such as, for example, by laser-etching or laser-patterning. Femtosecond lasers may be used in the laser-etching or laser-patterning process. One such example of a process or treatment to create superhydrophobic materials is a process developed by Dr. Chunlei Guo and Dr. A. Y. Vorobyev at the University of Rochester (2015). The process developed by Dr. Guo and Dr. Yorobyev uses femtosecond laser pulses to render metal superhydrophobic, thus making the treated surfaces “useful for [ . . . ] water/dust repelling.”

As shown in FIGS. 2 through 4, the guides are treated with a superhydrophobic process on the eye 407, shoulder 404, and leg 401 of the guide, as these are the components that come into direct contact with water. The heel 402, foot 405, and toe 403 of the guide (such as shown in FIG. 4) may or may not be treated, since these components do not come into contact with water. A person of ordinary skill in the art will understand that as more surface area is treated, the superhydrophobicity of the guide will increase and that, generally, the cost of production will also increase. Thus, a person of ordinary skill in the art will determine the areas to treat based upon factors such as, for example, the expected retail cost of the guide or fishing rod, the expected performance results of such a guide or fishing rod, and other like considerations.

In a preferred embodiment, one or more of the guides is comprised of a material that can be subjected to laser treatment and has a flat or curved interior surface of sufficient area to allow the interior surface of the guide to be treated by lasers or other type of micro- or nano-sized tool. Additionally, pre-treated materials can be affixed to the guides via a number of methods known to a person of ordinary skill in the art, including, for example, adhesive, welding, or a physical connection (e.g., nail or wire harness).

Alternatively, the one or more guides are square, rectangular, or of such other such parallelogram or multiple, complex, three-dimensional shape that presents an increased overall percentage of the outer surface of the guide to laser treatment. Alternatively, the guide material can be shaped to allow for laser treatment (e.g., in a sheet) and then formed into guides after treatment. Depending upon the level of sophistication, accuracy, and precision of the laser treatment set up, the entire guide can be laser treated and thus superhydrophobic. In other embodiments, the portions of the guide that cannot be treated, for any number of mechanical or economic reasons, are rounded, chamfered or otherwise shaped or processed to reduce friction associated with the line and to reduce sharp or rough edges contacting the line.

In another preferred embodiment, the guides are made to be superhydrophobic by other means, such as, for example, being composed of a natural or synthetic material that is inherently superhydrophobic or that can be caused to be superhydrophobic or more hydrophobic with permanent or semi-permanent coatings such as, for example, Manganese oxide polystyrene (MnO2/PS), nano-composite Zinc oxide polystyrene (ZnO/PS), nano-composite precipitated calcium carbonate, Carbon nanotube structures, Silica nano-coating or other like materials.

In another preferred embodiment, the superhydrophobic fishing rod guide is a guide composed of titanium/nickel alloy. The titanium/nickel alloy guides are affixed to a 274 centimeters long fly fishing rod, in the following order, beginning at the end of the fly fishing rod intended for the reel (called “the butt” end of the rod; see FIG. 1): a stripping guide, size 12, affixed to the fly fishing rod 78 centimeters from the butt end of the rod, an American pattern snake guide affixed to the rod 103 centimeters from the butt end of the fly fishing rod; an American pattern snake guide affixed to the fly fishing rod 128 12 centimeters from the butt end of the fly fishing rod; an American pattern snake guide affixed to the fly fishing rod 154 centimeters from the butt end of the fly fishing rod, an American pattern snake guide affixed to the fly fishing rod 178 centimeters from the butt section of the rod; an American pattern snake guide affixed to the fly fishing rod 198 2 centimeters from the butt end of the fly fishing rod; an American pattern snake guide affixed to the fly fishing rod 219 12 centimeters from the butt end of the fly rod; an American pattern snake guide affixed to the fly fishing rod 237 centimeters from the butt end of the fly fishing rod; an American pattern snake guide affixed to the fly fishing rod 252 centimeters from the butt end of the fly fishing rod; an American pattern snake guide affixed to the fly fishing rod 265 2 centimeters from the butt end of the fly fishing rod; and a “tip top” guide affixed to the rod tip. In an alternative embodiment, the snake guides vary in size depending on their placement on the length and weight of the rod, but generally run from sizes 3 to 1. In another preferred embodiment, the superhydrophobic tip top guide is composed of titanium/nickel alloy in size 4.5.

Additional embodiments for the stripping guide dimensions include sizes 80 to 3.5. Similarly, additional embodiments of the snake guide dimensions (for both American pattern snake guides and English pattern snake guides) include sizes 6 to 2/0. Likewise, additional embodiments for the tip top guide include sizes 18 to 5. Furthermore, additional embodiments can be made from a wide variety of metals and materials, including stainless steel, steel, titanium, titanium alloy, nickel silver, or any other metals and materials that are durable enough to function as a fishing rod line guide.

While our aforementioned preferred embodiment is specific to fly fishing rod line guides, our invention will be used for all styles of angling and their corresponding rods, including but not limited to ice fishing rods, spinning rods, baitcasting rods, surf rods, sea rods, telescopic rods and trolling rods. These alternative embodiment of rods can have a variety of superhydrophobic line guide types, including but not limited to single foot guides, roller guides, tip top guides, and micro guides, these guides are made in a range of sizes. Finally, the spacing of any combination of the aforementioned fishing rod guide types can range substantially, as different rod lengths, thicknesses, and flexibilities demand specific line guide combinations of size, type, and spacing.

1. A fishing apparatus comprising:
an elongated rod; and
a guide disposed the elongated rod, wherein the guide includes a hydrophobic section on the surface of the guide.

2. The fishing apparatus of claim 1, wherein the hydrophobic section is superhydrophobic.

3. The fishing apparatus of claim 2, where the hydrophobic section is a pattern etched into the surface of the guide.

4. The fishing apparatus of claim 2, where the hydrophobic section is a chemical coating disposed on the surface of the guide.

5. The fishing apparatus of claim 2, wherein the hydrophobic section is formed by a laser treatment.

6. The fishing apparatus of claim 2, wherein the hydrophobic section includes a microscale pattern.

7. The fishing apparatus of claim 2, wherein the hydrophobic section includes a nanoscale pattern.

8. The fishing apparatus of claim 2, wherein the hydrophobic section includes features that are between 2 nanometers to 50 nanometers in length.

9. A line guide for a fishing rod comprising:
an outer surface, wherein the outer surface includes a hydrophobic section.

10. The line guide of claim 9, wherein the hydrophobic section is superhydrophobic.

11. The line guide of claim 10, where the hydrophobic section is a pattern etched into the outer surface of the guide.

12. The line guide of claim 10, where the hydrophobic section is a chemical coating disposed on the outer surface of the guide.

13. The line guide of claim 10, wherein the hydrophobic section is formed by a laser treatment.

14. The line guide of claim 10, wherein the hydrophobic section includes a microscale pattern.

15. The line guide of claim 10, wherein the hydrophobic section includes a nanoscale pattern.

16. The line guide of claim 10, wherein the hydrophobic section includes features that are between 2 nanometers to 50 nanometers in length.

17. A method of creating a superhydrophobic guide for a fishing line, comprising the steps of: forming a guide for a fishing line having a semi-circular shape and an outer surface; and creating a pattern on the exterior to create a superhydrophobic section.

18. The method of claim 17, wherein said step of creating a pattern includes using laser-etching.

19. The method of claim 17, wherein said step of creating a pattern includes laser patterning.
The method of claim 17, wherein said step of creating includes using a femtosecond laser.
